(19) United States
(12) Patent Application Publication
(10) Pub. No.: US 2010/0132188 A1
(43) Pub. Date: Jun. 3, 2010

(54) Hand Tool for Coaxial Terminal

(76) Inventors: Chien-Chou Liao, Tu Cheng City (TW); Hsing-Chieh Ho, Tu Cheng City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/468,944

(22) Filed: May 20, 2009

(30) Foreign Application Priority Data
Nov. 28, 2008 (TW) 097221446

(51) Int. Cl. H01R 43/042; B23P 19/00

(52) U.S. Cl. 29/751

(57) ABSTRACT

A hand tool of the present invention is used for connecting a signal wire and a coaxial terminal. The hand tool comprises a first shaft, a second shaft, a pressing portion, a guiding portion, a U-shaped wire against portion, and a containing portion. The first shaft comprises a first holding portion and a slot, and the second shaft comprises a second holding portion, wherein the second shaft is pivoted to the first shaft. The signal wire is disposed in the second shaft away from the second holding portion, the pressing portion being connected to the first shaft, and the pressing portion can slide along the direction vertical to the second holding portion substantially. The pressing portion can slide in the guiding portion to connect the signal wire and the coaxial terminal. The U-shaped wire against portion is connected to the second shaft, wherein the U-shaped wire against portion is used for pressing the signal wire; and the signal wire and the coaxial terminal can be put in the containing portion.

### BACKGROUND OF THE INVENTION

1. Field of the Invention

The present invention relates to a hand tool, and more particularly, the present invention relates to a hand tool capable of connecting a wire and a coaxial terminal.

2. Description of the Related Art

A hand squeeze terminal wire connecting tool is a common hand tool. It is used for connecting a coaxial terminal to a signal wire whose size matches that of the coaxial terminal. Therefore, the signal wire can be fixed on a socket by the coaxial terminal. The signal can be transmitted steadily.

However, in the prior arts, the hand squeeze terminal wire connecting tools have complicated linkage structures. A typical structure of the hand squeeze terminal wire connecting tool is that a slant linkage drives a slide with a pressing element, sliding along the direction of the handle to connect the signal wire and the coaxial terminal. The manufacturing cost is higher because of the multiple components, which also contribute to frequent malfunctions during operation.

Furthermore, in some prior arts of the hand squeeze terminal wire connecting tool, a portion of the force exerted is lost in the process of squeezing and connecting. The loss of force is the result of force applied to the coaxial terminal along the handle is merely a fraction of the force transmitted from the slant linkage. If a user applies the squeezing movement repeatedly, the user will be tired easily.

Therefore, a hand tool having the characteristics of simplified structure, lower manufacturing cost, and more efficient transmission of force is needed to solve the problems of the prior art.

### SUMMARY OF THE INVENTION

The object of the present invention is to provide a hand tool for connecting a coaxial terminal to a signal wire with the characteristics of simplified structure and efficient transmission of force.

In order to achieve the above object, the hand tool of the present invention comprises a first shaft, a second shaft, a pressing portion, a guiding portion, a U-shaped wire against portion, and a containing portion. The first shaft comprises a first holding portion and a slot, and the second shaft comprises a second holding portion, wherein the second shaft is pivoted to the first shaft, and the signal wire is disposed in the second shaft away from the second holding portion. The pressing portion is connected to the first shaft, and the pressing portion can slide along the direction vertical to the second holding portion substantially; the pressing portion can slide in the guiding portion to connect the signal wire and the coaxial terminal. The U-shaped wire against portion is connected to the second shaft, wherein the U-shaped wire against portion is used for pressing the signal wire, and the signal wire and the coaxial terminal can be put in the containing portion.

### BRIEF DESCRIPTION OF THE DRAWINGS

FIG. 1 is a three dimensional diagram of a first embodiment of the hand tool of the present invention.

FIG. 2 is an exploded view of the first embodiment of the hand tool of the present invention.

FIG. 3 is a sectional view of the first embodiment of the hand tool of the present invention.

FIG. 4 is a three dimensional diagram of the first embodiment of the hand tool of the present invention when pressed.

FIG. 5 is a three dimensional diagram of a second embodiment of the hand tool of the present invention.

FIG. 6 is a three dimensional diagram of the second embodiment of the hand tool of the present invention when a signal wire and a terminal inserted.

FIG. 7 is a three dimensional diagram of the second embodiment of the hand tool of the present invention when pressed.

FIG. 8 is a three dimensional diagram of a third embodiment of the hand tool of the present invention.

FIG. 9 is a three dimensional diagram of the third embodiment of the hand tool of the present invention when a signal wire and a terminal are inserted.

FIG. 10 is a three dimensional diagram of the third embodiment of the hand tool of the present invention when pressed.

### DETAILED DESCRIPTION OF THE PREFERRED EMBODIMENT

The advantages and innovative features of the present invention will become more apparent from the following detailed description when taken in conjunction with the accompanying drawings.

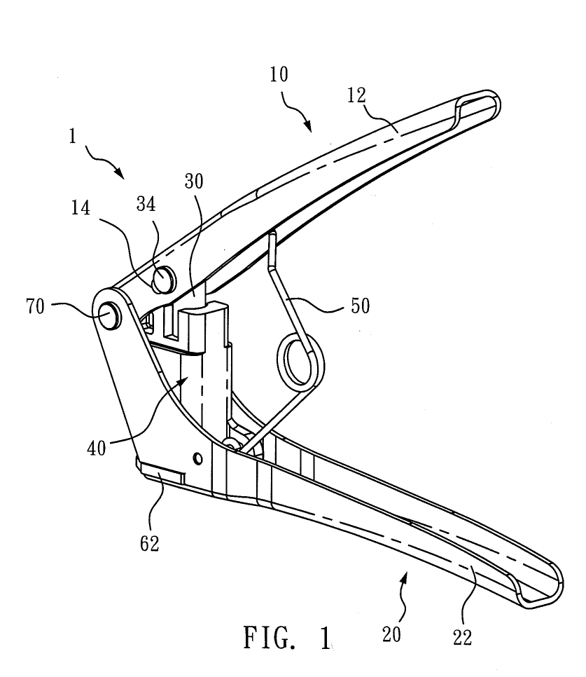

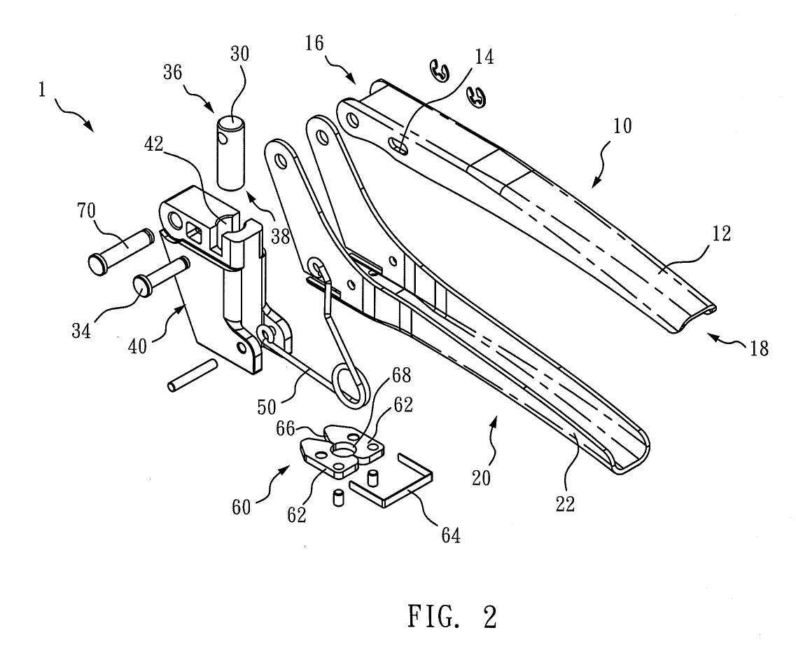

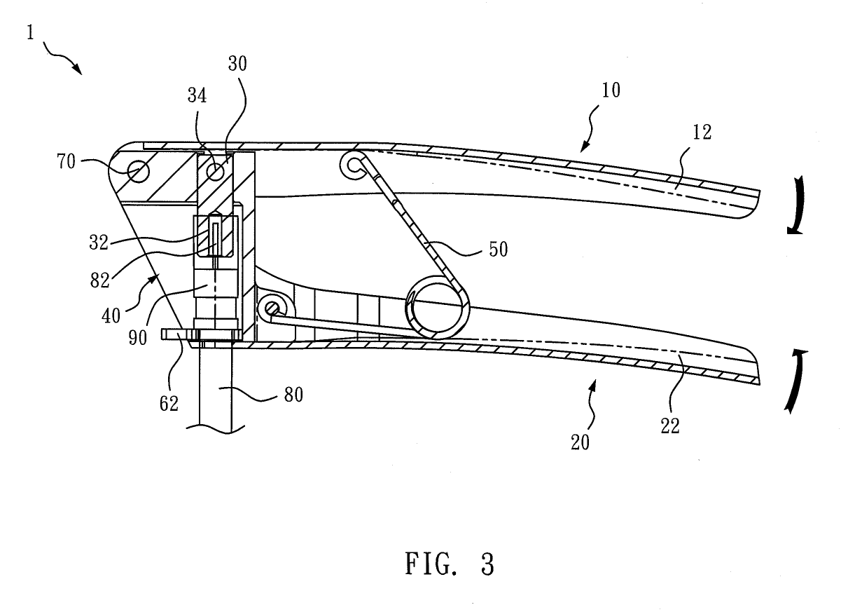

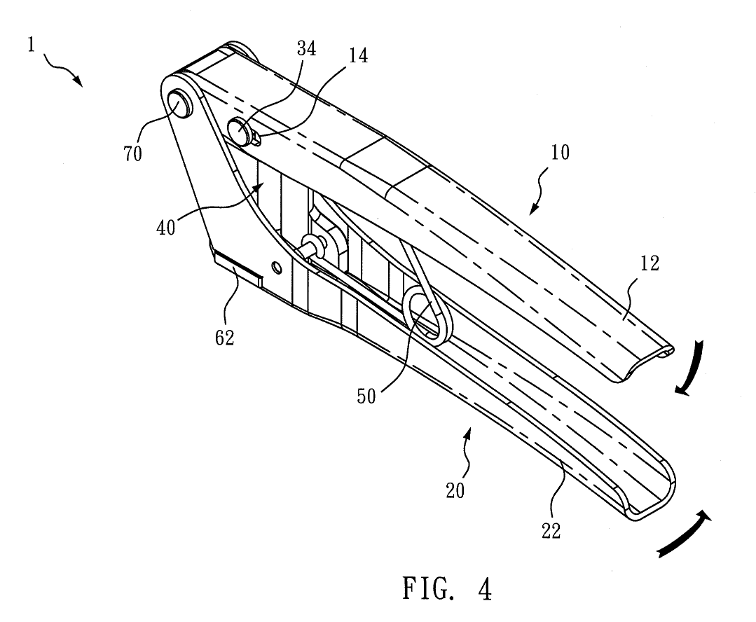

Please refer to FIG. 1 to FIG. 4 for the first embodiment of the hand tool of the present invention. FIG. 1 is a three dimensional diagram of a first embodiment of the hand tool of the present invention, FIG. 2 is an exploded view of the first embodiment of the hand tool of the present invention, FIG. 3 is a sectional view of the first embodiment of the hand tool of the present invention, and FIG. 4 is a three dimensional diagram of the first embodiment of the hand tool of the present invention when pressed.

The hand tool 1 is used for connecting a signal wire 80 with a conductor 82 to a coaxial terminal 90 (as shown in FIG. 3). The size of the signal wire 80 and the coaxial terminal 90 match with each other, and the signal wire 80 connects to the coaxial terminal 90 in one unity after the clipping process by the hand tool 1. The coaxial terminal 90 connects to the signal wire 80 in one unity by being compressed. The coaxial terminal 90 could be an F type coaxial terminal, a BNC type coaxial terminal, a RCA type coaxial terminal, or an IEC-type coaxial terminal, etc.

The hand tool 1 of the present invention mainly comprises a first shaft 10, a second shaft 20, a pressing portion 30, and a guiding portion 40.

The first shaft 10 comprises a first holding portion 12 and a slot 14. The first holding portion 12 is a handle for a user to hold directly. In the embodiment, the slot 14 is a long aperture. It needs to be noted that the structure and the shape of the slot 14 are not limited by the above description.

The second shaft 20 comprises a second holding portion 22, which is a handle for the user to hold directly. During the clipping process, the user holds the first holding portion 12 and the second holding portion 22 simultaneously. Because the first holding portion 12 and the second holding portion 22 are quite long, it produces a larger moment of force when being pressed.

The second shaft 20 is pivoted to the first shaft 10, such that the first shaft 10 and the second shaft 20 can be revolved relatively to a certain degree. The signal wire 80 is put in the position of the second shaft 20 away from the second holding portion 22 (as shown in FIG. 3). The first shaft 10 has an end portion 16 and an end portion 18. The end portion 18 is the opposite end of the end portion 16. In the embodiment, the first shaft 10 and the second shaft 20 are pivoted to the end portion 16 of the first shaft 10 by a pivot shaft 70, and the distance between the end portion 16 and the slot 14 is smaller than the distance between the slot 14 and the end portion 18.

The pressing portion 30 is an element that presses the coaxial terminal 90 directly during the clipping process. The pressing portion 30 is pivoted to the first shaft 10, and the end portion 36 of the pressing portion 30 can slide in the slot 14 along the direction vertical to the second holding portion 22. In this embodiment, the pressing portion 30 comprises a sliding axle 34. The pressing portion 30 connects to the first shaft 10 by a sliding axle 34, and the sliding axle 34 can slide in the slot 14. The sliding length of the sliding axle 34 is the length of the slot 14, and the sliding direction of the sliding axle 34 is along the extending direction of the first shaft 10.

Please refer to FIG. 3. Because the signal wire 80 has a conductor 82 (F type, for example) in the middle, it needs a containing space during the clipping process. The end portion 38 of the pressing portion 30 opposite to the end portion 36 further comprises a conductor containing portion 32. The shape and the position of the conductor containing portion 32 match the conductor 82. Therefore, when the pressing portion 30 presses the coaxial terminal 90, the conductor 82 is in the conductor containing portion 32. The end portion 38 of the pressing portion 30 can slide in the guiding portion 40 to clip the signal wire 80 and the coaxial terminal 90. In the embodiment, the guiding portion 40 comprises a sliding aperture 42, which matches the outer shape of the pressing portion 30 such that the pressing portion 30 can slide in the cylinder sliding aperture 42. It needs to be noted that the outer shape of the pressing portion 30 and the shape of the sliding aperture 42 are not limited by the above description.

In the embodiment, the sliding direction of the sliding axle 34 of the pressing portion 30 sliding in the slot 14 is different from the sliding direction of the end portion 38 of the pressing portion 30 sliding in the guiding portion 40. The purpose is that the moving direction of the clipping force changes to the vertical direction, as shown in FIG. 3.

During the clipping process, the included angle between the first shaft 10 and the second shaft 20 gradually becomes shorter (as shown in FIG. 4). In order to return to the original position (as shown in FIG. 1) after finishing the clipping process, the hand tool 1 further comprises an elastic element 50. The two ends of the elastic element 50 are respectively connected to the first shaft 10 and the second shaft 20. Therefore, the elastic element 50 is compressed and stores an elastic force during the clipping process of the hand tool 1. After finishing the clipping process, the user releases his or her grip. The elastic element 50 releases the elastic force, causing the first shaft 10 and the second shaft 20 to return to their original positions (as shown in FIG. 1). It needs to be noted that the types and the position of the elastic element 50 are not limited by the above description.

Furthermore, in order that the signal wire 80 can maintain the clipping position, the second shaft 20 further comprises a wire holding portion 60 for containing and positioning the signal wire 80. In the embodiment, the wire holding portion 60 is connected to the second shaft 20 (as shown in FIG. 1). The wire holding portion 60 comprises two holding units 62 (as shown in FIG. 2) which are symmetric with each other, and each holding unit 62 has a semicircle curved portion 68, wherein the shape of the curved portion 68 is approximately the same as the outer diameter of the signal wire 80. The signal wire 80 can slide from the slanted side 66 of the holding unit 62 into the curved portion 68. An elastic piece 64 is set on the outside of the wire holding portion 60. By the elastic piece 64 exerting pressure in the holding unit 62, the holding unit 62 can hold and position the signal wire 80 to prevent the signal wire 80 from changing its position such that the signal wire 80 and the coaxial terminal 90 are not aligned with each other, which would cause the clipping process to fail. In the embodiment, when the signal wire 80 is contained in the wire holding portion 60, the signal wire 80 is substantially vertical to the second holding portion 22.

The following illustrates the practical operation of the hand tool 1 of the present invention. First, the coaxial terminal 90 is set in the rear of the signal wire 80. At this time, the coaxial terminal 90 and the signal wire 80 are loose because they are not clipped yet. The signal wire 80 slides from the slanted side 66 in the curved portion 68 of the holding unit 62. At this time, the conductor containing portion 32 of the pressing portion 30 is aimed at the position of the conductor 82 of the signal wire 80.

Subsequently, the user holds the first shaft 10 and the second shaft 20 and applies force to the first shaft 10 and the second shaft 20 (the force direction is shown by arrows in FIG. 3 and FIG. 4). The force is transferred to the sliding axle 34 of the pressing portion 30 first. A fulcrum is formed in the sliding axle 34 of the pressing portion 30 in the slot 14, and the effort arm (from the slot 14 to the end portion 18) is far longer than the resistance arm (from the end portion 16 to the slot 14), so the user can conduct the clipping process in a force-saving manner.

Next, guided by the sliding aperture 42, the pressing portion 30 moves along the vertical direction. When the user gradually applies force to the first holding portion 12 and the second holding portion 22, the included angle between the first shaft 10 and the second shaft 20 decreases gradually. At this time, the pressing portion 30 moves downward gradually and touches the coaxial terminal 90. As the user applies force continuously, the coaxial terminal 90 presses toward the direction of the signal wire 80 to complete the operation of the clipping process.

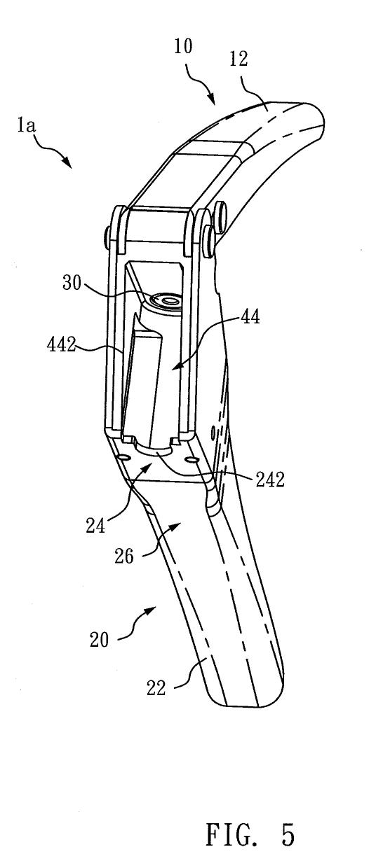

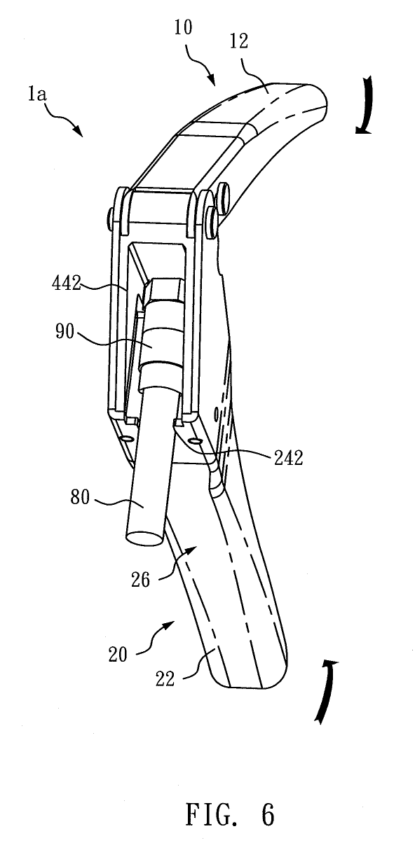

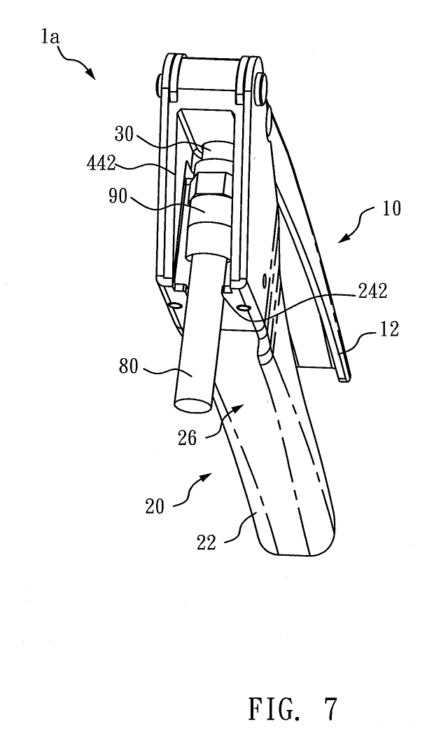

Please refer to FIG. 5 to FIG. 7, which illustrate a second embodiment of the present invention. FIG. 5 is a three dimensional diagram of a second embodiment of the hand tool of the present invention, FIG. 6 is a three dimensional diagram of the second embodiment of the hand tool of the present invention when a signal wire and a terminal are inserted, and FIG. 7 is a three dimensional diagram of the second embodiment of the hand tool of the present invention when pressed.

The hand tool la comprises a first shaft 10, a second shaft 20, a pressing portion 30, a guiding portion 40, a U-shaped wire against portion 24, and a containing portion 44. The difference from the first embodiment is that the signal wire 80 contacts the U-shaped wire against portion 24 and is contained in the containing portion 44 to achieve the purpose of fixing the position of the signal wire 80 and the coaxial terminal 90. The following is further description of the U-shaped wire against portion 24 and the containing portion 44.

The U-shaped wire against portion 24 is connected to the second shaft 20 and on the bottom surface 26 of the second shaft 20 (as shown in FIG. 5). The U-shaped wire against portion 24 is used for the signal wire 80 to lie on (as shown in FIG. 6). The U-shaped wire against portion 24 comprises an against portion opening 242. The shape of the against portion opening 242 matches the outer diameter of the signal wire 80. In this embodiment, the against portion opening 242 is approximately semicircular in shape, but its shape is not limited by the above description. In addition, in the embodiment, the U-shaped wire against portion 24 and the second shaft 20 are formed in one unity. For instance, it can be formed by casting or punching.

The containing portion 44 is concave in order to contain part of the signal wire 80 and the coaxial terminal 90. The containing portion 44 comprises a containing portion opening 442. The opening directions of the containing portion opening 442 and the against portion opening 242 are the same. Therefore, when part of the signal wire 80 and the coaxial terminal 90 are in the containing portion 44, the signal wire 80 is in the against portion opening 242. In the embodiment, the opening directions of the containing portion opening 442 and the against portion opening 242 are toward the front (as shown in FIG. 5). In addition, the containing portion 44 and the second holding portion 22 can be formed in one unity. For instance, it can be formed by casting or punching.

In the embodiment, when a user wants to conduct the clipping process using the hand tool 1a, the signal wire 80 and the coaxial terminal 90 are placed from the front of the hand tool 1a (as shown in FIG. 6) first so that the signal wire 80 and the coaxial terminal 90 sustain their clipping positions constantly. Then the user applies force to the first shaft 10 and the second shaft 20 in the direction of the arrows, as shown in FIG. 6, and the pressing portion 30 (as shown in FIG. 7) will move simultaneously and apply force downward. Finally, the coaxial terminal 90 presses toward the direction of the signal wire 80 such that the signal wire 80 and the coaxial terminal 90 are clipped into one unity.

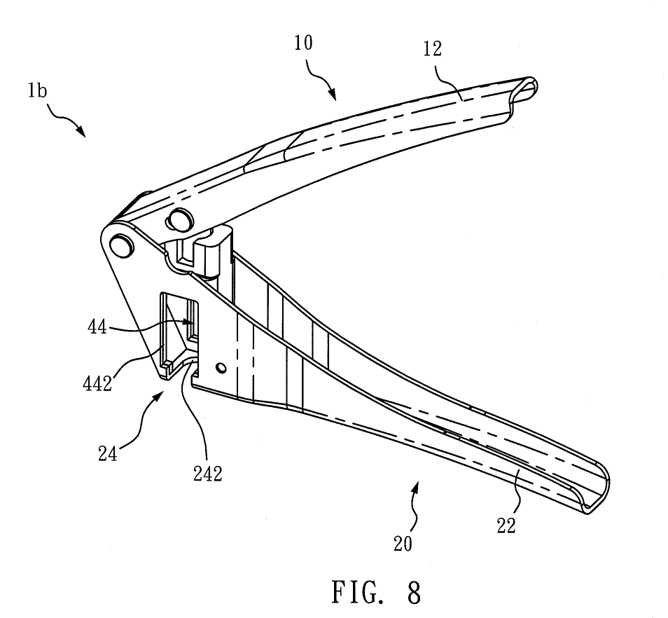

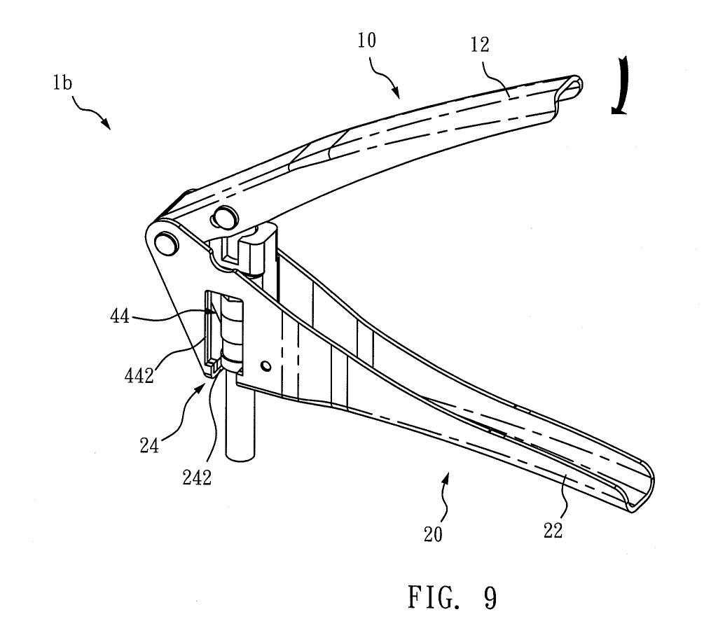

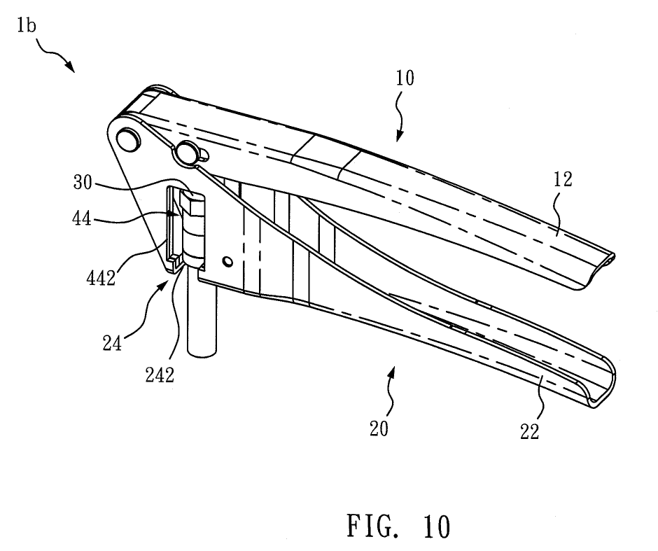

Please refer to FIG. 8 to FIG. 10, which illustrate a third embodiment of the present invention. FIG. 8 is a three dimensional diagram of a third embodiment of the hand tool of the present invention, FIG. 9 is a three dimensional diagram of the third embodiment of the hand tool of the present invention when a signal wire and a terminal are inserted, and FIG. 10 is a three dimensional diagram of the third embodiment of the hand tool of the present invention when pressed.

The difference from the second embodiment is in the opening direction of the containing portion opening 442 and the against portion opening 242. In this third embodiment, the opening directions of the containing portion opening 442 and the against portion opening 242 are toward the side (as shown in FIG. 9). Therefore, when a user wants to perform the clipping process using the hand tool 1b, the signal wire 80 and the coaxial terminal 90 are inserted from the side of the hand tool 1b.

In short, the hand tool of the present invention has a simplified and force-saving structure to achieve the purpose of clipping a coaxial terminal and a signal wire, and to reduce the manufacturing cost.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the present invention.

What is claimed is:

1. A hand tool for connecting a signal wire and a coaxial terminal, the hand tool comprising:
a first shaft comprising a first holding portion and a slot;
a second shaft comprising a second holding portion, wherein the second shaft is pivoted to the first shaft, and the signal wire is disposed in the second shaft away from the second holding portion;
a pressing portion, the pressing portion being connected to the first shaft; the pressing portion can slide along the direction vertical to the second holding portion substantially;
a guiding portion; the pressing portion can slide in the guiding portion to connect the signal wire and the coaxial terminal;
a U-shaped wire against portion connected to the second shaft, wherein the U-shaped wire against portion is used for pressing the signal wire; and
a containing portion; the signal wire and the coaxial terminal can be put in the containing portion.

2. The hand tool as claimed in claim 1, wherein the U-shaped wire against portion and the second shaft are formed in one union.

3. The hand tool as claimed in claim 2, wherein the second shaft comprises a bottom surface, the U-shaped wire against portion being on the bottom surface.

4. The hand tool as claimed in claim 3, wherein the containing portion comprises a containing portion opening, and the U-shaped wire against portion comprises an against portion opening, the containing portion opening and the against portion opening being toward the same direction.

5. The hand tool as claimed in claim 4, wherein the containing portion opening and the against portion opening are toward the front or the side.

6. The hand tool as claimed in claim 2, wherein the containing portion and the second shaft are formed in one union.

7. The hand tool as claimed in claim 1, wherein the guiding portion comprises a sliding aperture which matches the shape of the pressing portion.

8. The hand tool as claimed in claim 1, wherein the signal wire is vertical to the second holding portion substantially.

9. The hand tool as claimed in claim 1, wherein the coaxial terminal is F type, BNC type, RCA type, or IEC type.

10. A hand tool for connecting a signal wire and a coaxial terminal, the hand tool comprising:
a first shaft comprising a first holding portion and a slot;
a second shaft comprising a second holding portion, wherein the second shaft is pivoted to the first shaft, and the signal wire is disposed in the second shaft away from the second holding portion;
a pressing portion, the pressing portion being connected to the first shaft; the pressing portion can slide along the direction vertical to the second holding portion substantially; and
a guiding portion; the pressing portion can slide in the guiding portion to connect the signal wire and the coaxial terminal.

11. The hand tool as claimed in claim 10, wherein the second shaft further comprises a wire holding portion for putting and positioning the signal wire.

12. The hand tool as claimed in claim 11, wherein the wire holding portion comprises two holding units which are symmetrical with each other, and each holding unit has a semicircular curved portion.

13. The hand tool as claimed in claim 11, wherein the signal wire is vertical to the second holding portion.

14. The hand tool as claimed in claim 10, wherein the guiding portion comprises a sliding aperture which matches the shape of the pressing portion.

15. The hand tool as claimed in claim 10, further comprising an elastic element, wherein the two sides of the elastic element are connected to the first shaft and the second shaft respectively.

16. The hand tool as claimed in claim 10, wherein the signal wire comprises a conductor, and the pressing portion comprises a conductor containing portion; the conductor containing portion can contain the conductor.

17. The hand tool as claimed in claim 10, wherein the first shaft and the second shaft are pivoted to an end of the first shaft, and the distance between the end and the sliding aperture is smaller than the first shaft and the other end of the first shaft.

18. The hand tool as claimed in claim 17, wherein the pressing portion comprises a sliding axle, the pressing portion being connected to the first shaft by the sliding axle, and the sliding axle can slide in the sliding aperture.

19. The hand tool as claimed in claim 18, wherein the sliding aperture is long in shape.
